(19) United States
(12) Patent Application Publication
(10) Pub. No.: US 2016/0101700 A1
(43) Pub. Date: Apr. 14, 2016

(54) CONTROL SYSTEM AND METHOD FOR A VEHICLE

(71) Applicant: General Electric Company, Schenectady, NY (US)

(72) Inventors: Timothy Brown, Erie, PA (US); Jeffrey Wolff, Erie, PA (US); Henry Young, Erie, PA (US); Carlos Vallejo, Erie, PA (US); Sean Cillessen, Erie, PA (US); Kenneth Nedley, Erie, PA (US); Larry Bench, Casper, WY (US)

(21) Appl. No.: 14/974,430

(22) Filed: Dec. 18, 2015

Related U.S. Application Data
(63) Continuation of application No. PCT/US2015/010756, filed on Jan. 9, 2015.
Application No. PCT/US2015/010756 is a continuation-in-part of application No. 14/464,226, filed on Oct. 14, 2014, now Pat. No. 9,227,515.
(60) Provisional application No. 61/867,780, filed on Aug. 20, 2013.
(60) Provisional application No. 61/925,733, filed on Jan. 10, 2014.

(51) Int. Cl. B60L 7/26

(52) U.S. Cl. CPC B60L 7/26

(57) ABSTRACT

A control system for a vehicle includes an electric drive system associated with a first set of wheels. The electric drive system is configured to selectively provide electric motive power to the first set of wheels to propel the vehicle and electric retarding to slow the vehicle. The system further includes a friction brake system associated with one of the first set of wheels or a second set of wheels, a drive system control unit, and a friction brake control unit in electrical communication with the drive system control unit. The drive system control unit is configured to communicate with the friction brake control unit to control an amount of friction brake application during vehicle stops and starts on grade.

### CROSS-REFERENCE TO RELATED APPLICATION

This application is continuation of International Application PCT/US2015/010756, filed Jan. 9, 2015, which claims priority to U.S. Provisional Application No. 61/925,733, filed Jan. 10, 2014. This application also is a continuation-in-part of U.S. application Ser. No. 14/464,226, filed Aug. 20, 2014, which claims priority to U.S. Provisional Application No. 61/867,780 filed Aug. 20, 2013. All the aforementioned applications are incorporated by reference herein in their entireties.

### FIELD OF THE INVENTION

Embodiments of the invention relate generally to vehicle control. Other embodiments relate to a control system and method for braking a vehicle.

### BACKGROUND OF THE INVENTION

Large off-highway vehicles (“OHVs”), such as mining vehicles used to haul heavy payloads excavated from open pit mines, are well known and typically employ motorized wheels for propelling or retarding the vehicle in an energy efficient manner. This efficiency is typically accomplished by employing a large horsepower diesel engine in conjunction with an alternator, a main traction inverter, and a pair of wheel drive assemblies housed within the rear tires of the vehicle. The diesel engine is directly associated with the alternator such that the diesel engine drives the alternator. The alternator powers the main traction inverter, which supplies electrical power having a controlled voltage and frequency to electric drive motors of the two wheel drive assemblies. Each wheel drive assembly houses a planetary gear transmission that converts the rotation of the associated drive motor energy into a high torque low speed rotational energy output which is supplied to the rear wheels.

Braking of these large OHVs is typically accomplished using a “blended” brake system, that is, a combination of the electric dive system and friction brakes associated with the front and rear wheels. In particular, the electric drive system may be utilized not only to propel the vehicle, but to apply retarding tractive effort to the rear wheels to effect braking of the vehicle, as desired. In addition, or alternatively, the front and rear friction brakes may be applied in certain situations to bring the vehicle to a stop or to maintain the position of the vehicle when stopped. As will be readily appreciated, depending on the specific circumstance or application, the electric drive system, the front friction brakes and the rear friction brakes, or a combination of one or more of these braking elements, may be utilized for vehicle stopping and holding.

Operating loads in an OHV may exceed one hundred tons, while the gross weight of the vehicle and load may be several hundred tons. Operating these vehicles on grade and in wet conditions, therefore, can present several challenges, especially for inexperienced operators. In addition, operating such heavy vehicles in challenging conditions necessitates that braking system operate efficiently and reliably to prevent rollbacks when starting and stopping on grade. Accordingly, it is desirable to provide a system that automates the operation of a vehicle that is required to start and stop while loaded on grade.

### BRIEF DESCRIPTION OF THE INVENTION

In an embodiment, a control system (e.g., braking control system) for a vehicle comprises an electric drive system associated with at least a first set of wheels of the vehicle and a drive system control unit configured to control the electric drive system to selectively provide electric motive power to the at least the first set of wheels to propel the vehicle and electric retarding to slow the vehicle. The system further comprises a friction brake system associated with at least one of the first set of wheels or a second set of wheels of the vehicle, and a friction brake control unit configured to control the friction brake system for a friction brake application to the at least one of the first set of wheels or the second set of wheels. The drive system control unit is further configured to communicate with the friction brake control unit to control an amount of the friction brake application during vehicle stops and starts. For example, the drive system control unit may be configured to communicate with the friction brake control unit to at least partially automatically control the amount of the friction brake application during vehicle stops and starts on an inclined grade on which the vehicle is positioned.

In another embodiment, a method of controlling vehicle comprises, at a drive system control unit of the vehicle, controlling an electric drive system associated with at least a first set of wheels of the vehicle to selectively provide electric motive power to the at least the first set of wheels to propel the vehicle and electric retarding to slow the vehicle. The method further comprises determining a torque level needed to move the vehicle from stop to up an inclined grade, and, responsive to an input from an operator control for the vehicle to move up the grade, communicating with a friction brake control unit of the vehicle to remove a friction brake application that holds the vehicle stopped and concurrently controlling the electric drive system of the vehicle to provide the electric motive power according to the torque level that is determined, for the vehicle to move from stop to up the inclined grade without substantial vehicle rollback.

In another embodiment, a method of controlling a vehicle comprises, at a drive system control unit of the vehicle, controlling an electric drive system associated with at least a first set of wheels of the vehicle to selectively provide electric motive power to the at least the first set of wheels to propel the vehicle and electric retarding to slow the vehicle. The method further comprises determining a force needed to hold the vehicle on an inclined grade on which the vehicle is positioned, and communicating with a friction brake control unit of the vehicle to decrease or increase an amount of friction brake application applied to at least one of the first set of wheels or a second set of wheels of the vehicle, in dependence upon the force that is determined to hold the vehicle on the inclined grade.

### BRIEF DESCRIPTION OF THE DRAWINGS

The present invention will be better understood from reading the following description of non-limiting embodiments, with reference to the attached drawings, wherein below:

FIG. 1 is a perspective view of a vehicle according to an embodiment of the invention;

FIG. 2 is a schematic diagram of an electric drive and retarding system, according to an embodiment; and

FIG. 3 is a block diagram illustrating a control system including hydraulic friction brakes and an electric retarder, according to an embodiment.

### DETAILED DESCRIPTION OF THE INVENTION

Reference will be made below in detail to exemplary embodiments of the invention, examples of which are illustrated in the accompanying drawings. Wherever possible, the same reference numerals used throughout the drawings refer to the same or like parts. Although exemplary embodiments of the present invention are described with respect to haul trucks having a diesel engine that are utilized in the surface mining industry, embodiments of the invention are also applicable for use with internal combustion engines and vehicles employing such engines, generally. For example, the vehicles may be off-highway vehicles (“OHVs”) designed to perform an operation associated with a particular industry, such as mining, construction, farming, etc., and may include haul trucks, cranes, earth moving machines, mining machines, farming equipment, tractors, material handling equipment, earth moving equipment, etc. Alternatively or additionally, the vehicles may be on-road vehicles, such as tractor-trailer rigs, on-road dump trucks, etc. As used herein, “electrical communication” or “electrically coupled” means that certain components are configured to communicate with one another through direct or indirect signaling by way of direct or indirect electrical connections.

Embodiments of the invention relate to control systems and methods (e.g., braking control) for controlling transition from friction brakes to electrical effort (and vice versa) in a vehicle, to automate operation of the vehicle for starts and stops while loaded on an inclined (greater than zero degrees) grade. According to one aspect, for example, a control system (and related method) is configured for concurrent control of an electric drive system and a friction brake system of a vehicle to prevent rollback when the vehicle is operated to move from a stopped position on an inclined grade. According to another aspect, a control system (and related method) is configured for concurrent control of an electric drive system and a friction brake system of a vehicle, while traveling on an inclined grade, to bring the vehicle to a stop and hold the vehicle stopped.

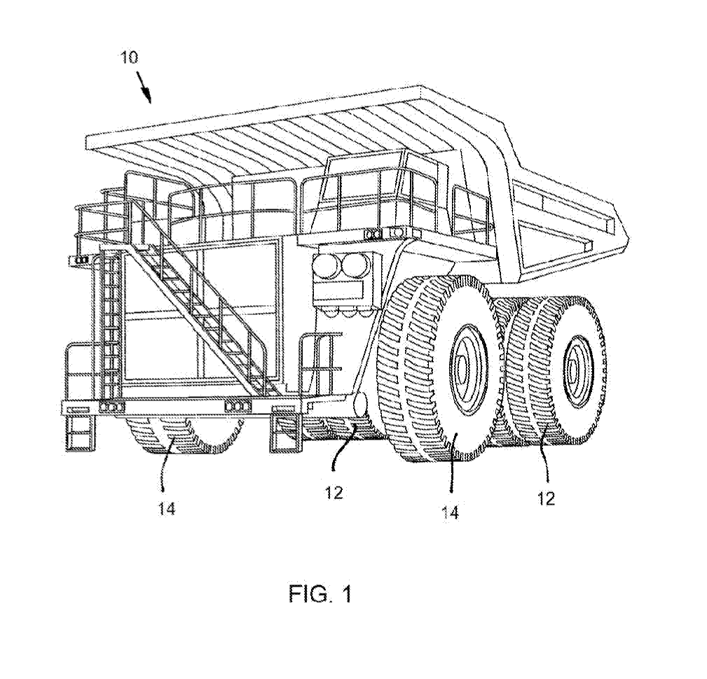

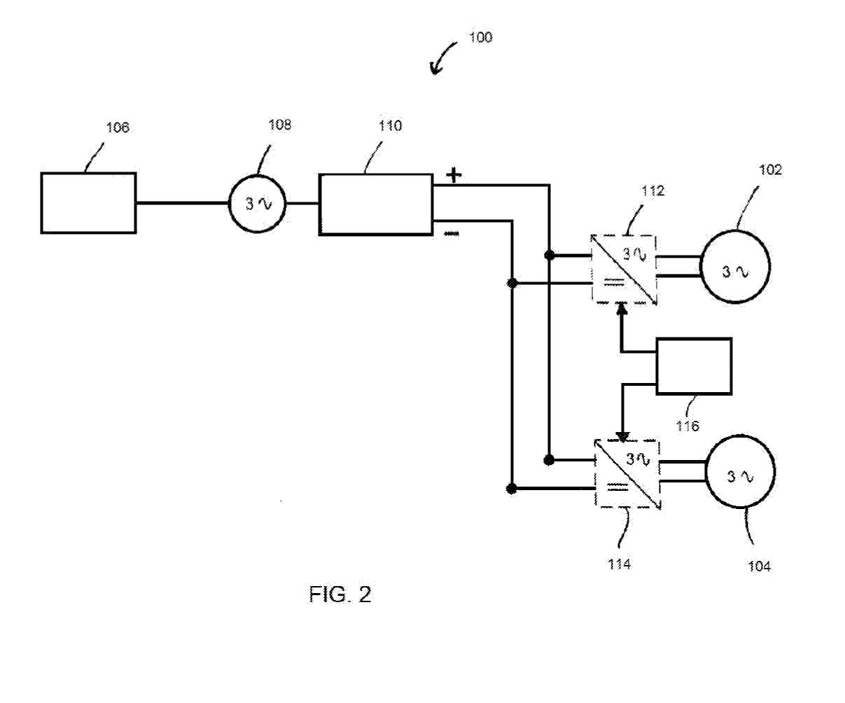

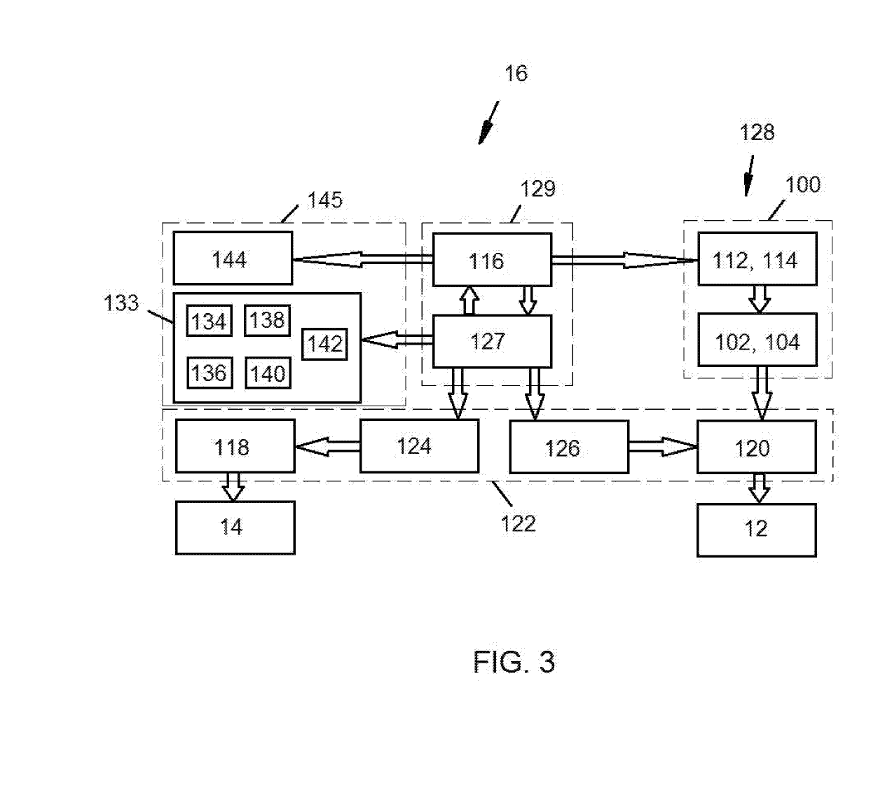

FIG. 1 illustrates a vehicle 10 in which a control system 16 of the present invention may be incorporated. (The control system 16 is described below in regards to FIG. 3 and elsewhere herein.) The vehicle 10, as illustrated, is a haul truck specifically engineered for use in high production mining and heavy-duty construction environments, and includes a first set of wheels 12, which may be rear wheels, and a second set of wheels 14, which may be front wheels. The first set of wheels 12 may be drive wheels that are coupled to an electric drive system 100 (see FIG. 2) which provides motive power to the haul truck 10. The second set of wheels 14 may be operably coupled to a vehicle steering system for vehicle steering. (The haul truck 10 is illustrative of vehicles generally, although in embodiments, a system and/or method of the invention is implemented on a haul truck specifically.)

An embodiment of the electric drive system 100 is shown in FIG. 2. The electric drive system 100 is at least partially housed within the vehicle 10, and comprises a three-phase alternating current (AC) generator/alternator 108 that is coupled to be mechanically driven by an engine 106 (e.g., a diesel engine). An AC output of the generator 108 is fed into one or more rectifiers 110, which are configured to convert the AC output of the generator/alternator 108 to a direct current (DC) output. The DC output of the rectifiers 110 is supplied to a DC bus, which (among other loads) feeds into a set of inverters 112, 114. The inverters 112, 114 are configured to convert DC power from the DC bus into controlled three-phase, variable frequency AC power. Outputs of the inverters 112, 114 are electrically connected to electric motors 102, 104 (respectively), and the AC power output by the inverters 112, 114 has a waveform suitable for driving the electric motors 102, 104. The electric motors 102, 104 are operably coupled to the drive wheels 12 of the first set of wheels. For example, the motors 102, 104 may be three-phase, AC induction wheel motors. If the second set of wheels 14 are drive wheels, then the electric drive system 100 would include additional inverters and electric motors coupled similarly to the inverters 112, 114 and motors 102, 104 in FIG. 2.

As further shown in FIG. 2, a drive system control unit 116 is electrically coupled to the electric drive system 100. For example, the drive system control unit may be connected to the inverters 112, 114. The drive system control unit 116, among other tasks, is configured to determine and send a desired torque request signal to the inverters 112, 114. The torque request signal is processed by the control unit for the inverters 112, 114 to drive the motors 102, 104 to the desired torque output magnitude, and in the desired rotational direction corresponding to the intended direction of vehicle movement. The control unit is also configured to control the motors 102, 104 to provide retarding tractive effort to the wheels 12 (e.g., rear wheels) to slow or stop the vehicle 10. In particular, when operating in an electric braking mode, also known as electric retarding, the electric motors 102, 104 are reversed to act as generators, and the drive wheels 12 of the vehicle 10 drive the electric motors 102, 104. Driving the motors 102, 104 places a torque on the drive wheels 12 and causes them to slow, thus braking the vehicle. In an embodiment, the control unit 116 includes one or more microprocessors operating according to a set of stored instructions to provide for vehicle control, as discussed in detail below and elsewhere herein.

FIG. 3 shows an embodiment of the control system (e.g., braking control system) 16 in more detail. The control system 16 comprises a friction brake system 122 that includes a first (e.g., rear) friction brake unit 120 (e.g., friction brake actuation unit) associated with the first set of wheels 12 (e.g., rear wheels) of the vehicle and a second (e.g., front) friction brake unit 118 (e.g., friction brake actuation unit) associated with the second set of wheels 14 (e.g., front wheels) of the vehicle. In an embodiment, the friction brake system 116 is a hydraulic brake system, which further includes a first (e.g., rear) brake solenoid valve 126 that is controllable to control the pressure of hydraulic fluid to the first friction brake unit 120, and a second (e.g., front) brake solenoid valve 124 that is controllable to control the pressure of hydraulic fluid to the second friction brake unit 118. In other embodiments, other means for actuating the first and second friction brake units 118, 120 may also be utilized without departing from the broader aspects of the present invention. In either (or any) embodiment, each friction brake unit may include, for example, respective components for controllably applying a friction load to a moving part associated with a wheel 12, 14, e.g., brake pads operably coupled with a vehicle axle or brake disc/rotor, hydraulically-actuated calipers for applying a force to the brake pads against the disc/rotor, and so on. The control system 16 further includes a friction brake control unit 127 that is configured to control application of the first and second (e.g., rear and front) friction brake units 120, 118 at least partially in response to operator inputs, such as the depression of a brake pedal.

In an embodiment, the drive system control unit 116 and friction brake control unit 127 are electrically coupled to one another and may be generally referred to as one or more controllers 129. While the drive system control unit 116 and friction brake control unit 127 are illustrated as separate components in FIG. 3, the control units 116, 127 may be integrated into a single control unit/controller/processor without departing from the broader aspects of the present invention.

As further shown in FIG. 3, the drive system control unit 116 is electrically coupled to the drive-train 128 of the vehicle 10, which includes the electric drive system 100, e.g., engine 106, generator 108, rectifier 110, inverters 112, 114, and drive motors 102, 104 (AC induction wheel motors as shown in FIG. 2, or otherwise). When braking the vehicle 10 in an electric retarder braking mode, the control unit 116 commands the electric drive system 100 (acting in effect as an electric retarding system that includes the inverters 112, 114, and motors 102, 104) to provide a requested desired vehicle retarding torque to the wheels.

As also shown in FIG. 3, one or both of drive system control unit 116 and/or the friction brake control unit 127 may be configured to receive inputs from an operator control 133, e.g., an ignition switch 134, an accelerator position transducer 136, a brake pedal position transducer 138, and/or a gear selector 140, for operating the electric motors 102, 104 for driving and braking the vehicle 10. The ignition switch 134 is operable to turn the vehicle on and off. The accelerator position transducer 136 is configured to detect a position of an accelerator pedal or other actuator. The brake pedal position transducer 138 is configured to detect a position of a brake pedal or other actuator. The gear selector 140 provides a means for permitting an operator to select an intended or desired direction of vehicle movement, such as forward movement or reverse movement. In addition or alternatively, the operator control may comprise another type of input interface 142, e.g., steering wheel or other steering controls, touchscreen or other computer interface, control input from a control system or autonomous controller, and so on. As further shown in FIG. 3, a display 144 may be electrically coupled to the drive system control unit 116 to allow an operator of the vehicle 10 to view status information relating to various vehicle systems. The display 144 and operator control(s) 133 collectively form an I/O (input/output) system 145.

With further reference to FIG. 3, the control system 16 is configured to automate the operation of the vehicle when starting and stopping, while loaded, on grade. In operation, when an operator of the vehicle (the operator may be a person or an autonomous controller) requests that the vehicle come to a stop, or that the vehicle move in a certain direction (e.g., in either case through actuation of an operator control), the drive system control unit 116 communicates with the friction brake control unit 127 to control a transition from friction brakes to electrical effort/propulsion, and vice versa. In particular, the control system 16 includes an interface between the drive system control unit 116 and the friction brake control unit 127 that allows the drive system control unit 116 (e.g., in response to feedback or other information from the electric drive system 100) to request a specific braking effort from the friction brake control unit 127. This interface also allows the drive system control unit 116 to request from the friction brake control unit 127 that friction braking effort be added or removed (i.e., increased or decreased). Thus, in embodiments, the drive system control unit 116 is configured to communicate with the friction brake control unit 127 to control an amount of a friction brake application during vehicle stops and starts. For example, the drive system control unit 116 may be configured to communicate with the friction brake control unit to at least partially automatically control the amount of the friction brake application during vehicle stops and starts on an inclined grade on which the vehicle is positioned. (At least partial automatic control means fully automatic control, or automatic control responsive to, and based in part on, an operator input, e.g., a degree or rate of braking or acceleration that is responsive and proportional to a degree of change in position of a brake pedal or accelerator pedal.)

In connection with the above, the drive system control unit 116 is configured to utilize system parameters to calculate the force needed to hold the vehicle 10 on the given inclined grade. The drive system control unit 116 then determines when to request the friction brakes be released or more friction braking effort be added in dependence upon this determined force. The force may be determined based on various methods as outlined in the aforementioned U.S. patent application Ser. No. 14/464,226, filed Aug. 20, 2014. Alternatively or additionally, the system 16 may be configured for the force to be determined based on information of the inclined grade as generated by an on-board inertial measurement unit, information on vehicle mass (e.g., determined from a weighing station, or from on-board, physics-based calculations from sensor data relating to vehicle acceleration under known conditions), other vehicle/system parameters (e.g., vehicle wheel radius), etc.

In embodiments, the control system 16 is also configured to provide anti-rollback capabilities. In particular, the drive system control unit 116 is configured to determine a torque level needed to move the vehicle from stop to up an inclined grade (i.e., the vehicle is stopped while on the inclined grade, and is then controlled to move up the inclined grade). The torque level may be determined based on the force, e.g., the torque level would be a level that at least just exceeds the force. Upon calculating the torque required (or at some point subsequent to calculating the torque), the drive system control unit 116 communicates with the friction brake control unit 127 to request removal of a friction brake application (i.e., amount of friction brake application=zero) to commence motion of the vehicle in the desired direction, without substantial rollback. Thus, in embodiments, the drive system control unit 116 is further configured, responsive to an input from an operator control (for the vehicle to move up down the inclined grade), to communicate with the friction brake control unit 127 to remove the friction brake application and concurrently control the electric drive system 100 to provide the electric motive power according to the torque level that is determined, for the vehicle to move from stop to up (or down) the inclined grade without substantial vehicle rollback. The drive system control unit 116 may be configured to communicate with the electric drive system and the friction brake control unit so that an amount and rate at which the friction brake application is removed (by the friction brake control unit controlling the friction brake system) is automatically controlled to be proportional or equivalent to an amount and rate at which additional torque is provided (by the electric drive system as controlled by the drive system control unit). For example, as the friction brake application is reduced by a particular amount, the torque is concurrently increased by an amount at least sufficient to offset the lowered friction brake application to prevent vehicle rollback until the friction brake application is completely removed, at which time additional torque is generated for the vehicle for move forward. (Without “substantial” vehicle rollback includes no vehicle rollback, and vehicle rollback below a threshold that is deemed to still meet designated safety guidelines, e.g., rollback of no more than 0.3 meters for certain haul truck applications.)

In other embodiments, the control system 16 is alternatively or additionally configured to provide controlled stop capabilities, such as when a vehicle 10 is operating on grade. In particular, the drive system control unit 116 is configured to calculate the force needed to hold the vehicle 10 on the given inclined grade, and, responsive to an input from an operator control for the vehicle to come to a stop while moving on the grade, to communicate with the friction brake control unit 127 to increase the amount of friction brake application, in dependence at least in part upon the force that is determined, to bring the vehicle to a stop and hold the vehicle stopped on the grade. The drive system control unit 116 may be further configured to calculate the force needed to bring the vehicle to a stop in the first place, and to simultaneously communicate with the friction braking control unit 127 to request an amount (and rate) of friction brake application to stop and then hold the vehicle the inclined grade. Generally, such calculations may take into account vehicle mass, current rate/velocity of travel, degree of grade incline, etc. For example, the braking force required to bring a vehicle to a stop while traveling up a grade would depend on vehicle mass and rate of deceleration (change in velocity from current velocity to zero over a given distance) less a factor due to rolling friction/resistance less a factor due to the force of gravity on the grade. The braking force then required to then hold the vehicle stopped on the grade would depend on vehicle mass, the grade, etc. as discussed above.

In embodiments, application of the friction brake system to bring a vehicle to a stop and hold the vehicle stopped on an inclined grade is concurrent with a reduction in electric retarding. Here, the drive system control unit 116 is configured to calculate the force needed to hold the vehicle 10 on the given inclined grade, and, concurrently with a reduction in the electric retarding, to communicate with the friction brake control unit to increase the amount of friction brake application, in dependence at least in part upon the force that is determined, to bring the vehicle to a stop and hold the vehicle stopped on the grade. Thus, as the vehicle is moving up an inclined grade, the drive system control unit 116, responsive to an input from an operator control for the vehicle to come to a stop, may be configured to first initiate electric retarding, and as the retarding effort by the electric drive system is reduced as the vehicle slows, concurrently communicate with the friction brake control unit to increase the amount of friction brake application. After the vehicle comes to a complete stop, the amount of electric retarding may be zero, and in such a case the amount of friction brake application will be sufficient to hold the vehicle stopped on the inclined grade. The drive system control unit 116 may be configured to automatically control the amount and rate by which the friction brake application increases concurrently with the decrease in electric retarding such that (i) an overall deceleration profile (change in velocity over time from a current non-zero velocity to zero velocity) of the vehicle is linear (and thereby smooth-seeming to human operators) and (ii) proportional in terms of rate to one or more inputs from an operator control, e.g., the drive system control unit would control the decrease in electric retarding and concurrent increase in friction braking to provide faster deceleration responsive to an input from an operator control for a higher degree/rate of braking versus an input from the operator control for a lower degree/rate of braking.

In embodiments, the control system is configured both for controlled stopping of a vehicle on an inclined grade, and anti-rollback as the vehicle is controlled to move forward (e.g., up the grade) from its stopped position. Here, the drive system control unit, responsive to a first input from an operator control for the vehicle to come to a stop while moving on the grade, is configured to determine the force (to hold the vehicle stopped on the grade), and (e.g., concurrently with a reduction in electric retarding) to communicate with the friction brake control unit to increase the amount of friction brake application, in dependence at least in part upon the force that is determined, to bring the vehicle to a stop and hold the vehicle stopped on the grade. The drive system control unit is further configured to determine a torque level needed to move the vehicle from stop to up the grade. The drive system control unit, responsive to a second input at the operator control for the vehicle to move up the grade, is further configured to: communicate with the friction brake control unit to remove the friction brake application; and concurrently control the electric drive system to provide the electric motive power according to the torque level that is determined, for the vehicle to move from stop to up the inclined grade without substantial vehicle rollback.

In another embodiment, a method of controlling a vehicle comprises, at a drive system control unit of the vehicle, controlling an electric drive system associated with at least a first set of wheels of the vehicle to selectively provide electric motive power to the at least the first set of wheels to propel the vehicle and electric retarding to slow the vehicle. The method further comprises, at the drive system control unit, determining a torque level needed to move the vehicle from stop to up an inclined grade. The method further comprises, at the drive system control unit, responsive to an input from an operator control for the vehicle to move up the grade, communicating with a friction brake control unit of the vehicle to remove a friction brake application that holds the vehicle stopped and concurrently controlling the electric drive system of the vehicle to provide the electric motive power according to the torque level that is determined, for the vehicle to move from stop to up the inclined grade without substantial vehicle rollback.

In another embodiment, a method of controlling a vehicle comprises, at a drive system control unit of the vehicle, controlling an electric drive system associated with at least a first set of wheels of the vehicle to selectively provide electric motive power to the at least the first set of wheels to propel the vehicle and electric retarding to slow the vehicle. The method further comprises, at the drive system control unit, determining a force needed to hold the vehicle on an inclined grade on which the vehicle is positioned. The method further comprises, at the drive system control unit, communicating with a friction brake control unit of the vehicle to decrease or increase an amount of friction brake application applied to at least one of the first set of wheels or a second set of wheels of the vehicle, in dependence at least in part upon the force that is determined to hold the vehicle on the inclined grade.

In another embodiment, a method of controlling a vehicle comprises, at a drive system control unit of the vehicle, controlling an electric drive system associated with at least a first set of wheels of the vehicle to selectively provide electric motive power to the at least the first set of wheels to propel the vehicle and electric retarding to slow the vehicle. The method further comprises, at the drive system control unit, determining a force needed to hold the vehicle on an inclined grade on which the vehicle is positioned. The method further comprises, at the drive system control unit, communicating with a friction brake control unit of the vehicle to decrease or increase an amount of friction brake application applied to at least one of the first set of wheels or a second set of wheels of the vehicle, in dependence at least in part upon the force that is determined to hold the vehicle on the inclined grade. The method further comprises, at the drive system control unit, receiving an input from an operator control for the vehicle to come to a stop while moving on the grade. The force is determined responsive to the input being received. The method further comprises, at the drive system control unit, communicating with the friction brake control unit to increase the amount of friction brake application, in dependence at least in part upon the force that is determined, to bring the vehicle to a stop and hold the vehicle stopped on the grade.

In another embodiment, a method of controlling a vehicle comprises, at a drive system control unit of the vehicle, controlling an electric drive system associated with at least a first set of wheels of the vehicle to selectively provide electric motive power to the at least the first set of wheels to propel the vehicle and electric retarding to slow the vehicle. The method further comprises, at the drive system control unit, determining a force needed to hold the vehicle on an inclined grade on which the vehicle is positioned. The method further comprises, at the drive system control unit, communicating with a friction brake control unit of the vehicle to decrease or increase an amount of friction brake application applied to at least one of the first set of wheels or a second set of wheels of the vehicle, in dependence at least in part upon the force that is determined to hold the vehicle on the inclined grade. The method further comprises, at the drive system control unit, receiving an input from an operator control for the vehicle to come to a stop while moving on the grade, wherein the force is determined responsive to the input being received. The method further comprises, at the drive system control unit, concurrently with a reduction in the electric retarding, communicating with the friction brake control unit to increase the amount of friction brake application, in dependence at least in part upon the force that is determined, to bring the vehicle to a stop and hold the vehicle stopped on the grade.

In another embodiment, a method of controlling a vehicle comprises, at a drive system control unit of the vehicle, controlling an electric drive system associated with at least a first set of wheels of the vehicle to selectively provide electric motive power to the at least the first set of wheels to propel the vehicle and electric retarding to slow the vehicle. The method further comprises, at the drive system control unit, determining a force needed to hold the vehicle on an inclined grade on which the vehicle is positioned. The method further comprises, at the drive system control unit, communicating with a friction brake control unit of the vehicle to decrease or increase an amount of friction brake application applied to at least one of the first set of wheels or a second set of wheels of the vehicle, in dependence at least in part upon the force that is determined to hold the vehicle on the inclined grade. The method further comprises, at the drive system control unit: receiving a first input from an operator control for the vehicle to come to a stop while moving on the grade (the force is determined responsive to the input being received); communicating with the friction brake control unit to increase the amount of friction brake application, in dependence at least in part upon the force that is determined, to bring the vehicle to a stop and hold the vehicle stopped on the grade; determining a torque level needed to move the vehicle from stop to up the grade; receiving a second input from the operator control for the vehicle to move up the grade; and responsive to receipt of the second input, communicating with the friction brake control unit to remove the friction brake application, and concurrently controlling the electric drive system to provide the electric motive power according to the torque level that is determined, for the vehicle to move from stop to up the inclined grade without substantial vehicle rollback.

In another embodiment, a method of controlling a vehicle comprises, at a drive system control unit of the vehicle, controlling an electric drive system associated with at least a first set of wheels of the vehicle to selectively provide electric motive power to the at least the first set of wheels to propel the vehicle and electric retarding to slow the vehicle. The method further comprises, at the drive system control unit, determining a force needed to hold the vehicle on an inclined grade on which the vehicle is positioned. The method further comprises, at the drive system control unit, communicating with a friction brake control unit of the vehicle to decrease or increase an amount of friction brake application applied to at least one of the first set of wheels or a second set of wheels of the vehicle, in dependence at least in part upon the force that is determined to hold the vehicle on the inclined grade. The method further comprises, at the drive system control unit: receiving a first input from an operator control for the vehicle to come to a stop while moving on the grade (the force is determined responsive to the input being received); concurrently with a reduction in the electric retarding, communicating with the friction brake control unit to increase the amount of friction brake application, in dependence at least in part upon the force that is determined, to bring the vehicle to a stop and hold the vehicle stopped on the grade; determining a torque level needed to move the vehicle from stop to up the grade; receiving a second input from the operator control for the vehicle to move up the grade; and responsive to receipt of the second input, communicating with the friction brake control unit to remove the friction brake application, and concurrently controlling the electric drive system to provide the electric motive power according to the torque level that is determined, for the vehicle to move from stop to up the inclined grade without substantial vehicle rollback.

As should be appreciated, therefore, the control system of the present invention helps resolve multiple issues relating to vehicle starts and controlled vehicle stop, on grade. In particular, embodiments of the control system may alleviate potentially unsafe vehicle movement during hill starts, such as unintentionally rolling backward on grade when commencing vehicle operation. Moreover, embodiments of the invention may simplify the driving process for operators. Whereas typical vehicles require an operator to control three pedals to safely and smoothly start and stop on grade, a vehicle incorporating the control and braking system of the present invention only requires that an operator control a single pedal (or perhaps a brake pedal and an accelerator pedal), as the control system automates the starting and stopping processes via communication and cooperation between the electric drive system and the friction brake system.

Embodiments of the invention also function to avoid rough stops that could potentially lead to equipment damage, and help bring the vehicle to a controlled stop by automatically controlling the transition from electric retarder braking to friction braking to hold the vehicle on grade. As a result, a vehicle incorporating the system is made easier to drive, and requires less expertise to operate. Moreover, easier to operate vehicles translate to smoother vehicle operation and less wear on components.

Embodiments of the invention are applicable, as noted above, to relatively large vehicles, for example, haul trucks and other vehicles having a gross vehicle operating weight of at least 250 metric tons. However, while the present invention has been described with specific reference to OHV's and other large vehicles of this type, the present invention is not intended to be so limited in this regard. In particular, it is contemplated that the present invention is equally applicable to electric vehicles generally, including but not limited to, electric off-highway vehicles, automobiles, and the like.

As noted above, the vehicle operator may be a person or an autonomous controller. Thus, “operator control” includes both controls that are operably by a human, and controls (e.g., control signals/inputs) associated with a control system/autonomous controller.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” “third,” “upper,” “lower,” “bottom,” “top,” etc. are used merely as labels, and are not intended to impose numerical or positional requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the invention, including the best mode, and also to enable one of ordinary skill in the art to practice the embodiments of invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

Since certain changes may be made in the control system and method for a vehicle, without departing from the spirit and scope of the invention herein involved, it is intended that all of the subject matter of the above description or shown in the accompanying drawings shall be interpreted merely as examples illustrating the inventive concept herein and shall not be construed as limiting the invention.

What is claimed is:

1. A control system, comprising:
an electric drive system associated with at least a first set of wheels of a vehicle;
a drive system control unit configured to control the electric drive system to selectively provide electric motive power to the at least the first set of wheels to propel the vehicle and electric retarding to slow the vehicle;
a friction brake system associated with at least one of the first set of wheels or a second set of wheels of the vehicle; and
a friction brake control unit configured to control the friction brake system for a friction brake application to the at least one of the first set of wheels or the second set of wheels;
wherein the drive system control unit is further configured to communicate with the friction brake control unit to control an amount of the friction brake application during vehicle stops and starts.

2. The control system of claim 1, wherein the drive system control unit is configured to communicate with the friction brake control unit to at least partially automatically control the amount of the friction brake application during vehicle stops and starts on an inclined grade on which the vehicle is positioned.

3. The control system of claim 2, wherein:
the drive system control unit is configured to determine a force needed to hold the vehicle on the inclined grade, and to communicate with the friction brake control unit to decrease or increase the amount of the friction brake application in dependence at least in part upon the force that is determined.

4. The control system of claim 3, wherein the drive system control unit, responsive to an input from an operator control for the vehicle to come to a stop while moving on the grade, is configured to:
determine the force; and
communicate with the friction brake control unit to increase the amount of friction brake application, in dependence at least in part upon the force that is determined, to bring the vehicle to a stop and hold the vehicle stopped on the grade.

5. The control system of claim 3, wherein the drive system control unit, responsive to an input from an operator control for the vehicle to come to a stop while moving on the grade, is configured to:
determine the force; and
concurrently with a reduction in the electric retarding, communicate with the friction brake control unit to increase the amount of friction brake application, in dependence at least in part upon the force that is determined, to bring the vehicle to a stop and hold the vehicle stopped on the grade.

6. The control system of claim 3, wherein:
the drive system control unit, responsive to a first input from an operator control for the vehicle to come to a stop while moving on the grade, is configured to:
determine the force; and
communicate with the friction brake control unit to increase the amount of friction brake application, in dependence at least in part upon the force that is determined, to bring the vehicle to a stop and hold the vehicle stopped on the grade;
the drive system control unit is further configured to determine a torque level needed to move the vehicle from stop to up the grade; and
the drive system control unit, responsive to a second input at the operator control for the vehicle to move up the grade, is further configured to: communicate with the friction brake control unit to remove the friction brake application; and concurrently control the electric drive system to provide the electric motive power according to the torque level that is determined, for the vehicle to move from stop to up the inclined grade without substantial vehicle rollback.

7. The control system of claim 3, wherein:
the drive system control unit, responsive to a first input from an operator control for the vehicle to come to a stop while moving on the grade, is configured to:
determine the force; and
concurrently with a reduction in the electric retarding, communicate with the friction brake control unit to increase the amount of friction brake application, in dependence at least in part upon the force that is determined, to bring the vehicle to a stop and hold the vehicle stopped on the grade;
the drive system control unit is further configured to determine a torque level needed to move the vehicle from stop to up the grade; and
the drive system control unit, responsive to a second input at the operator control for the vehicle to move up the grade, is further configured to: communicate with the friction brake control unit to remove the friction brake application; and concurrently control the electric drive system to provide the electric motive power according to the torque level that is determined, for the vehicle to move from stop to up the inclined grade without substantial vehicle rollback.

8. The control system of claim 1, wherein:
the drive system control unit is configured to determine a torque level needed to move the vehicle from stop to up an inclined grade; and
the drive system control unit is further configured, responsive to an input from an operator control for the vehicle to move up the grade, to communicate with the friction brake control unit to remove the friction brake application and concurrently control the electric drive system to provide the electric motive power according to the torque level that is determined, for the vehicle to move from stop to up the inclined grade without substantial vehicle rollback.

9. The control system of claim 1, wherein the drive system control unit, responsive to an input from an operator control for the vehicle to come to a stop while moving on an inclined grade, is configured to:
determine a force needed to hold the vehicle stopped on the inclined grade; and
communicate with the friction brake control unit to increase the amount of friction brake application, in dependence at least in part upon the force that is determined, to bring the vehicle to a stop and hold the vehicle stopped on the grade.

10. The control system of claim 1, wherein:
the drive system control unit, responsive to a first input from an operator control for the vehicle to come to a stop while moving on an inclined grade, is configured to: determine a force needed to hold the vehicle stopped on the inclined grade; and communicate with the friction brake control unit to increase the amount of friction brake application, in dependence at least in part upon the force that is determined, to bring the vehicle to a stop and hold the vehicle stopped on the grade;
the drive system control unit is further configured to determine a torque level needed to move the vehicle from stop to up the inclined grade; and
the drive system control unit, responsive to a second input at the operator control for the vehicle to move up the grade, is further configured to communicate with the friction brake control unit to remove the friction brake application and concurrently control the electric drive system to provide the electric motive power according to the torque level that is determined, for the vehicle to move from stop to up the inclined grade without substantial vehicle rollback.

11. The control system of claim 1, wherein:
the drive system control unit and the friction brake control unit are a single, integrated controller.

12. The control system of claim 1, wherein a gross vehicle operating weight of the vehicle is at least 250 metric tons, the first set of wheels are rear wheels of the vehicle, the friction brake system is associated with at least the second set of wheels of the vehicle, and the second set of wheels are front wheels of the vehicle.

13. A method of controlling a vehicle, comprising:
at a drive system control unit of the vehicle, controlling an electric drive system associated with at least a first set of wheels of the vehicle to selectively provide electric motive power to the at least the first set of wheels to propel the vehicle and electric retarding to slow the vehicle;
at the drive system control unit, determining a torque level needed to move the vehicle from stop to up an inclined grade; and
at the drive system control unit, responsive to an input from an operator control for the vehicle to move up the grade, communicating with a friction brake control unit of the vehicle to remove a friction brake application that holds the vehicle stopped and concurrently controlling the electric drive system of the vehicle to provide the electric motive power according to the torque level that is determined, for the vehicle to move from stop to up the inclined grade without substantial vehicle rollback.

14. A method of controlling a vehicle, comprising:
at a drive system control unit of the vehicle, controlling an electric drive system associated with at least a first set of wheels of the vehicle to selectively provide electric motive power to the at least the first set of wheels to propel the vehicle and electric retarding to slow the vehicle;
at the drive system control unit, determining a force needed to hold the vehicle on an inclined grade on which the vehicle is positioned; and
at the drive system control unit, communicating with a friction brake control unit of the vehicle to decrease or increase an amount of friction brake application applied to at least one of the first set of wheels or a second set of wheels of the vehicle, in dependence at least in part upon the force that is determined to hold the vehicle on the inclined grade.

15. The method of claim 14, further comprising, at the drive system control unit:
receiving an input from an operator control for the vehicle to come to a stop while moving on the grade, wherein the force is determined responsive to the input being received; and
communicating with the friction brake control unit to increase the amount of friction brake application, in dependence at least in part upon the force that is determined, to bring the vehicle to a stop and hold the vehicle stopped on the grade.

16. The method of claim 14, further comprising, at the drive system control unit:
receiving an input from an operator control for the vehicle to come to a stop while moving on the grade, wherein the force is determined responsive to the input being received; and
concurrently with a reduction in the electric retarding, communicating with the friction brake control unit to increase the amount of friction brake application, in dependence at least in part upon the force that is determined, to bring the vehicle to a stop and hold the vehicle stopped on the grade.

17. The method of claim 14, further comprising, at the drive system control unit:
receiving a first input from an operator control for the vehicle to come to a stop while moving on the grade, wherein the force is determined responsive to the input being received;
communicating with the friction brake control unit to increase the amount of friction brake application, in dependence at least in part upon the force that is determined, to bring the vehicle to a stop and hold the vehicle stopped on the grade;
determining a torque level needed to move the vehicle from stop to up the grade;
receiving a second input from the operator control for the vehicle to move up the grade; and
responsive to receipt of the second input, communicating with the friction brake control unit to remove the friction brake application, and concurrently controlling the electric drive system to provide the electric motive power according to the torque level that is determined, for the vehicle to move from stop to up the inclined grade without substantial vehicle rollback.

18. The method of claim 14, further comprising, at the drive system control unit:
receiving a first input from an operator control for the vehicle to come to a stop while moving on the grade, wherein the force is determined responsive to the input being received;
concurrently with a reduction in the electric retarding, communicating with the friction brake control unit to increase the amount of friction brake application, in dependence at least in part upon the force that is determined, to bring the vehicle to a stop and hold the vehicle stopped on the grade;
determining a torque level needed to move the vehicle from stop to up the grade;
receiving a second input from the operator control for the vehicle to move up the grade; and
responsive to receipt of the second input, communicating with the friction brake control unit to remove the friction brake application, and concurrently controlling the electric drive system to provide the electric motive power according to the torque level that is determined, for the vehicle to move from stop to up the inclined grade without substantial vehicle rollback.
